(19) United States
(12) Patent Application Publication
(10) Pub. No.: US 2006/0114936 A1
(43) Pub. Date: Jun. 1, 2006

(54) Enhanced processing methods for wireless base stations

(75) Inventor: Matthijs Paffen, Munich (DE)

Correspondence Address: WOLF GREENFIELD & SACKS, PC;FEDERAL RESERVE PLAZA, 600 ATLANTIC AVENUE, BOSTON, MA, 02210-2206, US

(73) Assignee: Analog Devices, Inc., Norwood, MA (US)

(21) Appl. No.: 11/001,469

(22) Filed: Dec. 1, 2004

(51) Int. Cl. H04J 3/22; H04J 3/16; H04L 12/56; H04L 12/28; H04Q 7/00

(52) U.S. Cl. 370/469; 370/329

(57) ABSTRACT

A method for use in a wireless communication system includes performing at least part of physical layer processing in one or more digital signal processors of a selected type, and performing at least part of medium access control processing in the same one or more digital signal processors. The physical layer processing may include coding, spreading and modulation. The medium access control layer processing may include placing data units in queues according to priority and scheduling data units for transmission or retransmission.

### FIELD OF THE INVENTION

This invention relates to wireless communication systems and, more particularly, to enhanced processing methods typically used in wireless base stations.

### BACKGROUND OF THE INVENTION

A simplified block diagram of a prior art wireless communication system is shown in FIG. 7. Data is transferred between a base station 10 and a mobile station (UE) 12 using a radio interface 16. Base station 10 is managed by a radio network controller (RNC) 18 using an IUB interface 17. A protocol structure of base station 2 can be divided into a physical (PHY) layer 14 and a medium access control (MAC) layer 15 based on the two lower horizontal layers of an open system interconnection (OSI) standard model well known in communication systems.

The universal mobile telecommunications system (UMTS) is a third generation mobile communication system. The data generated at higher layers of the UMTS terrestrial radio access network (UTRAN) is handled by transport channels, mapped onto physical channels in the physical layer 14 and is transmitted between the mobile station 12 and the base station 15. Typical functions of physical layer 14 include data multiplexing, channel coding, spreading and modulation. The medium access control layer 15 exchanges information through a transport channel with the physical layer 14. The medium access control layer 15 places packets received from the radio network controller 18 in queues according to priority and schedules transmissions according to priority. In addition, the medium access control layer 15 makes decisions on retransmissions based on feedback information received from the mobile station 12.

In prior art systems, a base station host processor 30 performs MAC layer processing and physical layer processing is performed by a combination of digital signal processors, ASICs (application specific integrated circuits) and FPGAs (field programmable gate arrays). In particular, symbol rate encoding 32 and symbol rate decoding 34 may be performed by a digital signal processor, and chip rate processing 36, 37 may be performed by ASICS, FPGAs, and/or digital signal processors. This architecture requires different software tools and different memories for MAC layer and physical layer processing and requires a communication channel between the base station host processor 30 and the symbol rate processing 32, 34 performed by the digital signal processor. This architecture leads to latencies in the processing of wireless communication signals. Such latencies may be undesirable in some applications and may be unacceptable in other applications.

A UMTS data transmission method known as the high speed downlink packet access (HSDPA) system provides a high speed downlink for packet switch connections from the base station to the mobile station (user equipment). The HSDPA system includes, on the downlink to the user equipment, a shared control channel (HS-SCCH) and a shared data channel (HS-DSCH) and on the uplink from the user equipment to the base station, a dedicated physical control channel (HS-DPCCH). The uplink physical control channel contains feedback information for the base station, including an acknowledgement of whether the data block has been received properly (an ACK/NACK signal) and a channel quality indicator (CQI) for adaptive coding and modulation.

The HSDPA system uses a hybrid automatic repeat request (HARQ) process for retransmitting packets. If a packet is corrupted during transmission, the HARQ process transmits another packet containing additional information needed for recovery. The retransmitted packet may contain the same information as the previously transmitted packet, or may contain additional information for data recovery. The processing of the feedback information, including the acknowledgement and the channel quality indicator, is performed by a MAC sublayer for HSDPA processing called the MAC-hs sublayer. However, the response time of the base station after it receives the feedback information from the user equipment is constrained by the time when the HARQ process is offered a time slot for retransmission of the data packet. During that time, the base station needs to perform despreading and decoding of the uplink control channel data and encoding and spreading of the downlink control channel and data channel. This requires a very quick response to the feedback information. In prior art base station architectures, wherein processing is divided between a host processor and one or more digital signal processors, it is difficult to meet the retransmission latency constraints of the HSDPA system.

Accordingly, there is a need for improved processing methods for wireless base stations.

### SUMMARY OF THE INVENTION

According to a first aspect of the invention, a processing method is provided for use in a wireless communication system. The processing method comprises performing at least part of physical layer processing in one or more digital signal processors of a selected type, and performing at least part of medium access control processing in the same one or more digital signal processors.

According to a second aspect of the invention, a processing method is provided for use in a base station of a wireless communication system. The processing method comprises performing at least part of symbol rate processing in one or more digital signal processors of a selected type, and performing at least part of transmission scheduling in the same one or more digital signal processors.

According to a third aspect of the invention, a method is provided for high speed downlink packet access (HSDPA) processing in a base station of a wireless communication system. The processing method comprises performing at least part of HSDPA physical layer processing in one or more digital signal processors of a selected type, and performing at least part of HSDPA media access control (MAC-hs) sublayer processing in the same one or more digital signal processors. The HSDPA physical layer processing may include storing retransmission data in a virtual buffer prior to encoding of the data units.

According to a fourth aspect of the invention, a processing method is provided for use in a base station of a wireless communication system. The processing method comprises maintaining one or more queues of data units to be transmitted from the base station to user equipment, wherein maintaining one or more queues is performed by one or more digital signal processors of a selected type, scheduling transmission of the data units from the base station to the user equipment, wherein scheduling transmission is performed by the same one or more digital signal processors, and processing the scheduled data units for transmission from the base station to the user equipment, wherein processing is performed by the same one or more digital signal processors.

### BRIEF DESCRIPTION OF THE DRAWINGS

For a better understanding of the present invention, reference is made to the accompanying drawings, which are incorporated herein by reference and in which:

FIG. 1 is a simplified block diagram of a wireless communication system in accordance with an embodiment of the invention;

FIG. 2 is a simplified block diagram of a wireless base station in accordance with an embodiment of the invention;

FIG. 3 is a high level flow diagram of shared downlink data processing of the transport channels performed by the media access control layer and the physical channels in the physical layer of a wireless base station in accordance with an embodiment of the invention;

FIG. 4 is a flow chart of an example of an implementation of a process for loading data units into queues in the base station in accordance with an embodiment of the invention;

FIG. 5 is a flow chart of an example of an implementation of a downlink process for scheduling and transmitting data units in accordance with an embodiment of the invention;

FIG. 6 is a flow chart of an example of an implementation of an uplink process for handling feedback information from user equipment in accordance with an embodiment of the invention; and

FIG. 7 is a simplified block diagram of a prior art wireless base station.

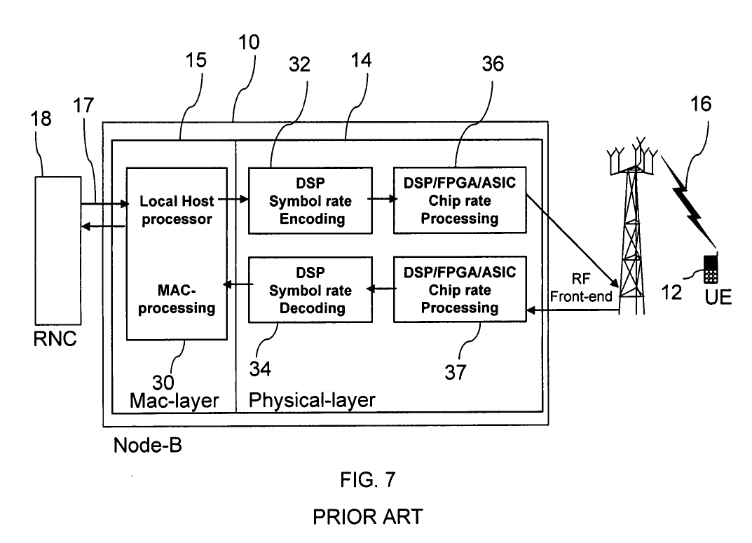

### DETAILED DESCRIPTION

According to aspects of the invention, a wireless communication system is capable of handling packet data with decreased latency in comparison with prior art systems. A base station is implemented such that one or more digital signal processors of a selected type perform at least part of the medium access control layer processing and at least part of the physical layer processing. Thus, one or more digital signal processors execute a combination of medium access control layer and physical layer processing. The digital signal processor is configured to schedule, allocate and distribute tasks to the physical layer and the medium access control layer. Thus, the digital signal processor can switch between physical layer and medium access control layer processing.

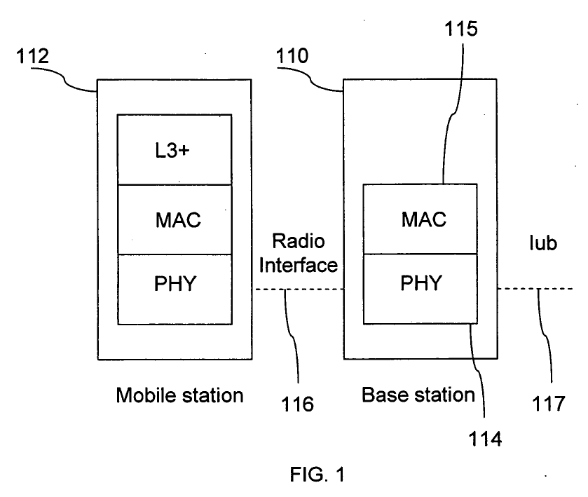

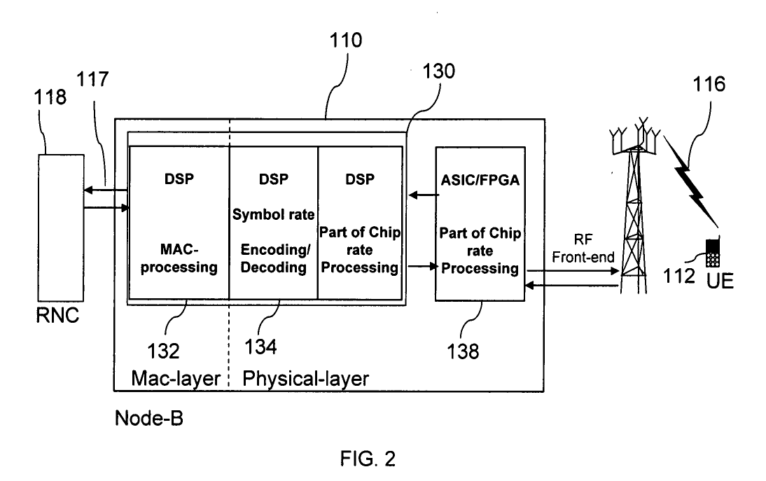

A wireless communication system in accordance with an embodiment of the invention is shown schematically in FIGS. 1 and 2. The wireless communication system includes a base station 110 and a mobile station 112 (also referred to herein as user equipment). Data is transferred between base station 110 and mobile station 112 using a radio interface 116. Base station 110 is managed by a radio network controller (RNC) 118 using an IUB interface 117. The protocol structure of base station 110 can be divided into a physical (PHY) layer 114 and a medium access control (MAC) layer 115 based on the two lower horizontal layers of an open system interconnection (OSI) standard model well known in a communication system.

The physical layer 114 of the base station 110 handles transmission of data using a wireless physical channel between mobile station 112 and the radio network controller 118 which passes the generated data from and to the UMTS terrestrial radio access network (UTRAN). Typical functions of the physical layer 114 include data multiplexing, channel coding, spreading and modulation. Medium access control layer 115 stores data in queues according to priority, schedules data units for transmission and handles retransmission of data.

As shown in FIG. 2, a digital signal processor (DSP) 130 performs MAC layer processing 132 and symbol rate encoding and decoding 134. Chip rate processing is divided between digital signal processor 130 and an ASIC and/or FPGA 138. In the embodiment of FIG. 2, at least part of the MAC layer processing and at least part of the physical layer processing are performed by a single digital signal processor 130. A suitable digital signal processor is the TigerSharc Digital Signal Processor sold by Analog Devices, Inc. In other embodiments, the MAC layer processing and the physical layer processing are performed by two or more digital signal processors, preferably of the same type. For example, two or more digital signal processors can be utilized in a multiprocessor configuration for increased computational capability and optimal use of the external interfaces for multiprocessor communication. In other embodiments, the ASIC and/or FPGA is not utilized for chip rate processing, and all chip rate processing is performed by digital signal processor 130. In other embodiments, at least part of the MAC layer processing and at least part of the physical layer processing are performed by DSP 130 and part of the MAC layer processing is performed on a host processor.

The configuration of FIG. 2 can use a common memory, does not require communication between a host processor and a digital signal processor, utilizes a single set of development tools, and reduces development costs. Accordingly, processing can be performed efficiently and with reduced latencies. Also, enhanced 3G services demand an increased amount of medium access control layer functions and intermediate data storage requirements in the base station. Medium access control layer processing and physical layer processing on one or one type of digital signal processor are made feasible by the increased amount of available memory and the fast throughput of the peripherals of state of the art digital signal processors.

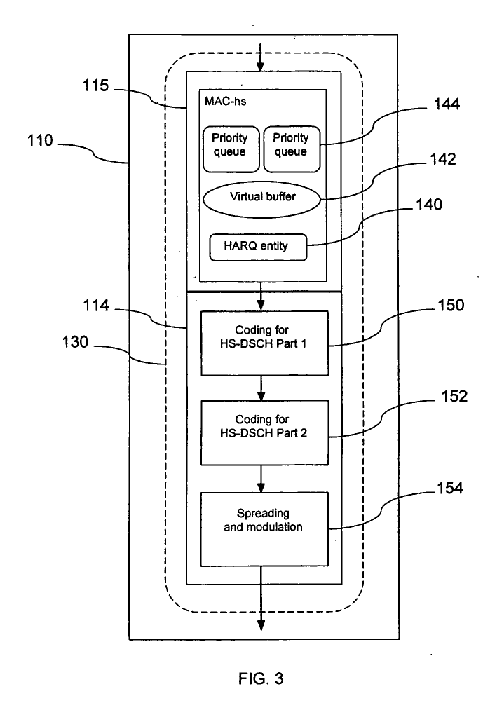

FIG. 3 is a simplified flow chart of shared downlink data processing of the transport channels performed by the media access control layer and the physical channels in the physical layer of a wireless base station in accordance with an embodiment of the invention. MAC layer processing and physical layer processing are described in connection with HSDPA processing. The MAC layer 115 includes a MAC sublayer called a MAC-hs sublayer for HSDPA processing. The MAC-hs sublayer is placed over physical layer 114 and controls packet scheduling, buffering, transmission and retransmission of data blocks that are received from the RNC and transmitted on the shared data channel (HS-DSCH). The MAC-hs sublayer is also responsible for management of the physical resources allocated to the shared data channel (HS-DSCH).

A HARQ block includes several HARQ entities for controlling HARQ processes for each user equipment. One HARQ entity 140 is provided for each user equipment in the HARQ block. There are several HARQ processes in each HARQ entity 140. Each HARQ process is used for transmission of a data block. If a specific data block is successfully received by the user equipment, the HARQ process is used for transmission of another data block. The HARQ process retransmits the data block until it is successfully received or discarded. The HARQ process requires a virtual buffer 142 for storage of the data block between transmission and a possible retransmission.

The MAC layer 115 further includes a priority queue 144 for each priority level. Data units are supplied to MAC layer 115 of base station 110 by the radio network controller (RNC) 118 (FIG. 2) and are stored in one of the priority queues 144 according to priority level, depending on the service. A data block is formed by one or several data units and is delivered to HARQ entity 140. The HARQ entity 140 uses a HARQ process which transmits the data block during one transmission time interval (TTI) and stores the data block in virtual buffer 142 for potential retransmission.

The data block is supplied to physical layer 114 for coding, spreading and modulation. From a high-level view, the physical layer processing of the shared data channel HS-DSCH can be broken into two parts. The first part performs encoding and produces redundant information which will not be changed between the first transmission and any of the retransmissions. The second part contains a mechanism which alters the redundant information or picks a different subset of the redundant information and can differ for the first transmission and any of the retransmissions. The physical layer 114 processing includes a part one channel coding block 150, a part two channel coding block 152 and a spreading and modulation block 154. The retransmitted data block of one HARQ process can differ from the previous transmitted data block by changing the redundancy version. A parameter defined as the redundancy version controls two modules, called constellation rearrangement and second rate-matching of the HARQ process. A different redundancy version has an impact on part two channel coding block 152 of the channel encoding chain. The general approach is that the data block of one HARQ process is stored just before the second channel coding block 152 so that no additional processing of the previous stages is required during a retransmission.

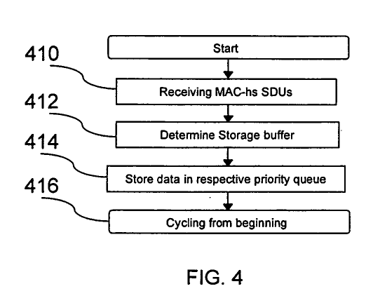

FIG. 4 is a flow chart of a process in accordance with an embodiment of the invention, wherein the priority queues 144 in MAC layer 115 are filled by the RNC 118. In step 410, SDUs (Service Data Units) are received from RNC 118. The MAC-hs SDUs include data and a header and are scheduled in the priority queues depending on information of higher layers. In step 412, the proper storage buffer in the MAC-hs layer is determined based on information of the MAC or higher layers. In step 414, the data of the SDU is stored in the respective queues according to priority. Each queue 144 operates as a FIFO. One or more MAC-hs SDUs are combined to form a MAC-hs PDU (payload data unit). A scheduler can take a MAC-hs PDU to transmit to one user equipment during one transmission time interval (TTI). Data is removed from the queues for transmission by the downlink signaling or flow control process described below. In step 416, the process recycles.

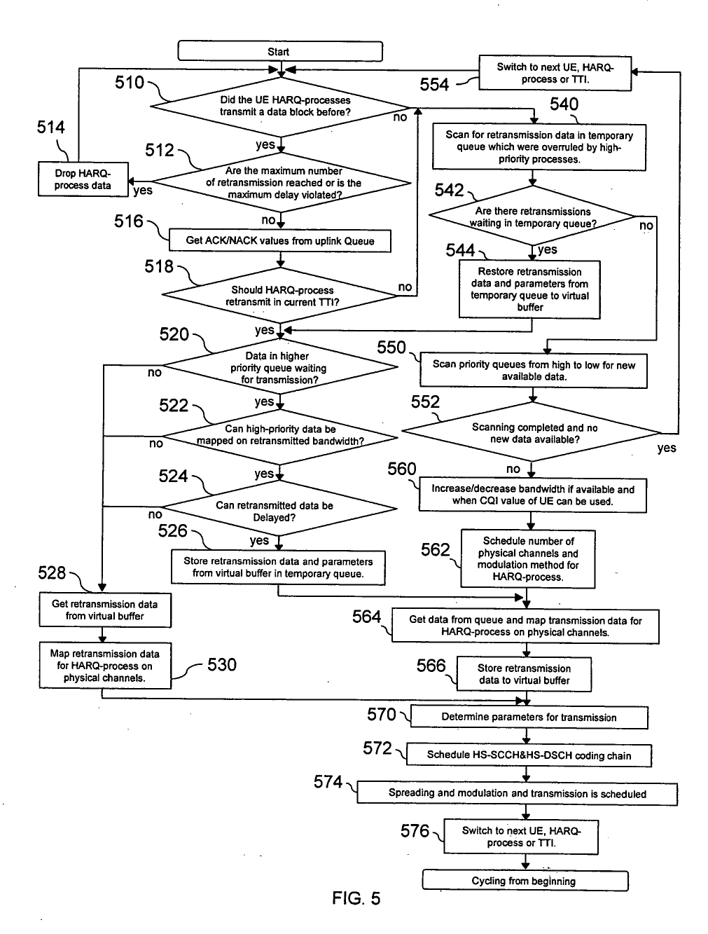

A flow chart of a downlink signaling process from base station 110 to user equipment 112, in accordance with an embodiment of the invention, is shown in FIG. 5. In step 510, a determination is made as to whether the HARQ process transmitted the same data block previously or is unoccupied. If a data block was transmitted previously, a determination is made in step 512 as to whether the maximum number of retransmissions has been reached or the maximum delay has been violated. If the maximum number of retransmissions has been reached or the maximum delay has been violated, the HARQ process data is dropped, and the HARQ process status changes to unoccupied in step 514 and the process returns to step 510. If the maximum number of retransmissions has not been reached and the maximum delay has not been violated, respective ACK/NACK acknowledge values associated with that HARQ process are obtained from an uplink queue in step 516. In step 518, a determination is made, based on the ACK/NACK acknowledge values, as to whether the HARQ process should retransmit in a current transmission time interval (TTI). If the HARQ process should not retransmit in the current TTI, the process proceeds to step 540, as described below.

If the HARQ process should retransmit in the current TTI, a determination is made in step 520 as to whether data is waiting for transmission in a higher priority queue. If data is waiting for transmission in a higher priority queue, a determination is made in step 522 as to whether the high priority data can be mapped on the bandwidth which the current HARQ process has available for retransmission of the current data block. The bandwidth depends on the number of scheduled physical channels and the type of modulation. If the high priority data can be mapped on the same bandwidth or available bandwidth, a determination is made in step 524 as to whether the current retransmitted data block can be delayed. If the current retransmitted data block can be delayed, the retransmission data and parameters from the virtual buffer 142 are stored in a temporary queue in step 526. From this point on, the higher-priority data block has overruled the current retransmitted data block and the process then proceeds to step 564 as described below.

If data which has a higher priority is not waiting for transmission in a queue as determined in step 520, if the high priority data cannot be mapped on the retransmitted bandwidth as determined in step 522 or if the retransmitted data cannot be delayed as determined in step 524, retransmission data is obtained from virtual buffer 142 in step 528. The data was stored in the virtual buffer during the first transmission in step 566. The retransmission data for the HARQ process is mapped to the physical channels in step 530. The process then proceeds to step 570 as described below.

If a data block was not transmitted previously for the current HARQ process as determined in step 510, or an ACK acknowledge value corresponding to the current HARQ-process is obtained from the uplink queue in steps 516 and 518, the temporary queue is scanned in step 540 for retransmission data which was overruled by a higher priority process. This temporary queue can be filled in previously-described step 526. In step 542, a determination is made as to whether retransmission data is waiting in the temporary queue. If retransmission is data in waiting in the temporary queue, the retransmission data and parameters are restored from the temporary queue to the virtual buffer 142 in step 544. The process then proceeds to step 520 as described above.

In an alternative implementation, high-priority data cannot interrupt retransmissions of a data block in the current HARQ process. In this implementation, steps 520, 522, 524, 526, 542 and 544 are not needed. If in step 518 the HARQ process needs to retransmit data, it will continue with step 528 and get the retransmission data from the virtual buffer 142, and then continue from this step. If in step 510 the current HARQ process did not transmit before and is unoccupied or the HARQ process should not retransmit as determined in step 518, then the priority queues are scanned from high to low for new available data in step 550.

If retransmission data is not waiting in the temporary queue as determined in step 542, the priority queues are scanned from high to low priority for new available data in step 550. Note that the priority queues are filled with new data in step 414 as described above. In step 552, a determination is made as to whether scanning of the priority queues is completed and no new data is available. If new data is not available, the process switches to the next user equipment, HARQ process or TTI in a nested iterative fashion in step 554 and returns to step 510. In connection with step 554, it should be noted that the flow chart does not imply that the process is executed from beginning to end dealing with only one user equipment or HARQ process at a time. Scheduling HARQ processes or user equipment may result in the chain being interrupted and other HARQ processes going through the same or different stages of the process during this time. Also note that transmission to one user equipment does not need to take place during every sequential TTI, which means that the HARQ process can be allocated to different users per TTI. With step 554, allocation of a HARQ process to a user equipment is performed.

If new data is available as determined in step 552, the bandwidth is increased or decreased in step 560. If there were transmissions to this user equipment before, the Channel Quality Index (CQI) value and the available bandwidth can be used to determine whether to increase or decrease the bandwidth to this user equipment. If this is the first transmission to this user equipment, then, depending on the service and based on availability, an initial bandwidth is chosen. In step 562, the number or a group of physical channels and the modulation method for the HARQ process are scheduled. In step 564, one or more MAC-hs SDUs are obtained from the queue and the transmission data for the HARQ process is mapped to physical channels. Several parameters, such as the Version-flag, queue-ID, and transmission sequence number, are determined and with this information a MAC-hs header is created. By appending the MAC-hs SDUs to the MAC-hs header, the MAC-hs PDU is formed and is scheduled. In step 566, the retransmission data is stored to the virtual buffer 142. As discussed below, the retransmission data is stored earlier in the process than in prior art systems. In step 570, physical layer parameters for transmission are determined and in step 572 the control channel (HS-SCCH) and the data channel (HS-DSCH) encoding processing are scheduled in advance of the TTI where the actual transmission needs to be performed. In step 574, spreading, modulation and transmission are scheduled so that the processing is finished before the point in time where the actual transmission is required. The scheduled physical layer processing can be performed on the DSP with a separate process or can be performed on another DSP or processing unit. In step 576, the process switches to the next user equipment, HARQ process or TTI, similar to step 554, and returns to step 510.

As shown in FIG. 5 and described above, retransmission data is stored in virtual buffer 142 (FIG. 3) in step 566 prior to encoding of the data in step 572. By storing the retransmission data prior to encoding, less storage space is required. The retransmission data can be stored in virtual buffer 142 at any convenient point in the physical layer or the MAC layer prior to encoding. By storing data prior to encoding, no additional performance is required, since the processor needs the processing performance margin for the worst case, where every data block is transmitted properly, thereby not requiring retransmissions and requiring execution of the complete encoding chain.

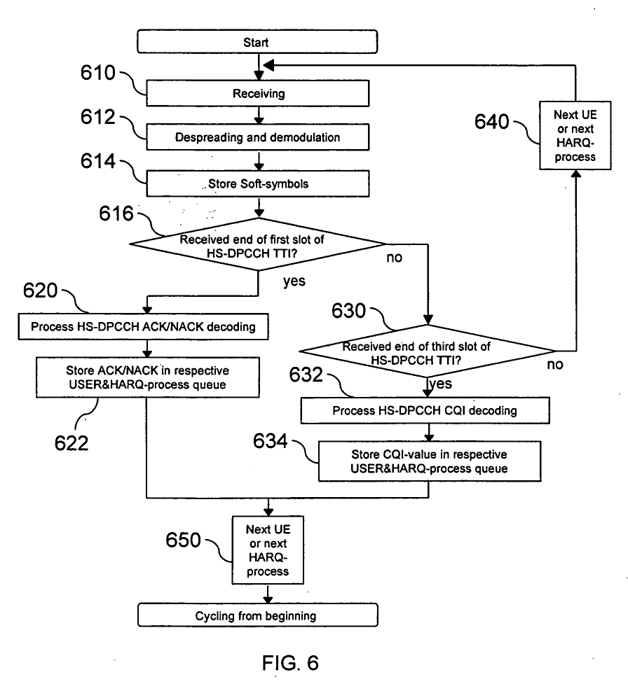

A flow chart of an uplink signaling process from the user equipment 112 to the base station 110, in accordance with an embodiment of the invention, is shown in FIG. 6. Steps 610, 612 and 614 represent receiving signals from the user equipment, despreading and demodulation of the received signals and storing the received symbols, respectively. In step 616, a determination is made as to whether the end of the first slot of the TTI (Transmit Time Interval) has been received. If the end of the first slot of the TTI has been received and demodulated, the ACK/NACK acknowledge value is decoded in step 620 and the ACK/NACK acknowledge value is stored in the respective user and HARQ process queue in step 622.

If the end of the first slot of the TTI has not been received as determined in step 616, a determination is made in step 630 as to whether the end of the third slot of the TTI has been received and demodulated. If the end of the third slot of the TTI has been received and demodulated, the CQI (Channel Quality Information) value is decoded in step 632 and the CQI value is stored in the respective user and HARQ process queue in step 634. If the end of the third slot of the TTI has not been received as determined in step 630, the process switches to the next user equipment or the next HARQ process in step 640 and returns to step 610. Following step 622 or step 634, the process switches to the next user equipment or the next HARQ process in step 650, similar to step 554 of FIG. 5 described above, and returns to step 610.

In an alternative implementation physical control channel HS-DPCCH despreading and demodulation can be scheduled together with decoding. This is feasible since despreading of the physical control channel HS-DPCCH is not required to detect the end of a slot. From receiving in step 610, the process can directly continue to step 616. If the end of the first slot within the TTI is detected, physical control channel HS-DPCCH despreading and demodulation are performed. The soft symbols are passed to step 620, where the ACK/NACK acknowledge value is decoded. The process is then continued as described in the previous implementation by storing this value in step 622. If the end of the first slot within the TTI is not detected and the end of the third slot within the TTI is detected, then physical control channel HS-DPCCH despreading and demodulation are performed and the soft symbols are passed to step 632 where the CQI value is decoded. The process is then continued, as described in the previous implementation, with step 634.

The processing techniques of the present invention are described herein in connection with wireless base stations. However, the disclosed processing methods may be utilized in other wireless system components and other wireless communication applications.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

What is claimed is:

1. A processing method for use in a wireless communication system, comprising:
performing at least part of physical layer processing in one or more digital signal processors of a selected type; and
performing at least part of medium access control layer processing in the one or more digital signal processors.

2. A processing method as defined in claim 1, wherein performing at least part of the medium access control layer processing comprises scheduling transmission of data units from a base station to user equipment.

3. A processing method as defined in claim 2, wherein performing at least part of the physical layer processing comprises performing at least part of the symbol rate processing of data units for transmission from the base station to user equipment.

4. A processing method as defined in claim 2, wherein performing at least part of the medium access control layer processing further comprises maintaining one or more queues of data units to be transmitted from the base station to the user equipment.

5. A processing method as defined in claim 3, wherein the physical layer processing comprises spreading and modulation of the data units for transmission.

6. A processing method as defined in claim 1, wherein performing at least part of the medium access control layer processing comprises processing acknowledge/not acknowledge signals transmitted from user equipment to a base station.

7. A processing method as defined in claim 1, wherein performing at least part of the medium access control layer processing includes scheduling retransmission of data units in response to not acknowledge signals from user equipment.

8. A processing method as defined in claim 2, wherein scheduling transmission of data units includes scheduling transmission of data units for two or more users.

9. A processing method as defined in claim 1, wherein performing at least part of medium access control layer processing comprises adjusting transmission parameters in response to channel quality information received from user equipment.

10. A processing method as defined in claim 3, wherein performing at least part of the physical layer processing further comprises performing at least part of chip rate processing of data units for transmission from the base station to the user equipment.

11. A processing method as defined in claim 1, wherein at least part of the physical layer processing and at least part of the medium access control layer processing are performed by a single digital signal processor.

12. A processing method as defined in claim 1, wherein at least part of the physical layer processing and at least part of the medium access control layer processing are performed by two or more digital signal processors in a multiprocessor configuration.

13. A processing method as defined in claim 1, wherein at least part of the physical layer processing and at least part of the medium access control layer processing are performed by two or more digital signal processors of the same type or family.

14. A processing method as defined in claim 1, wherein the physical layer processing includes encoding of data units for transmission and storing retransmission data in a virtual buffer prior to the encoding of the data units.

15. A processing method for use in a base station of a wireless communication system, comprising:
performing at least part of symbol rate processing in one or more digital signal processors of a selected type; and
performing at least part of transmission scheduling in the one or more digital signal processors.

16. A processing method as defined in claim 15, wherein the symbol rate processing and the transmission scheduling are performed by a single digital signal processor.

17. A processing method as defined in claim 15, wherein the symbol rate processing and the transmission scheduling are performed by two or more digital signal processors in a multiprocessor configuration.

18. A processing method as defined in claim 15, wherein the symbol rate processing and the transmission scheduling are performed by two or more digital signal processors of the same type or family.

19. A processing method as defined in claim 15, wherein the symbol rate processing includes encoding of data units for transmission and storing retransmission data in a virtual buffer prior to the encoding of the data units.

20. A method for high speed downlink packet access (HSDPA) processing in a base station of a wireless communication system, comprising:
performing at least part of HSDPA physical layer processing in one or more digital signal processors of a selected type; and
performing at least part of HSDPA media access control (MAC-hs) sublayer processing in the one or more digital signal processors.

21. A processing method as defined in claim 20, wherein the HSDPA physical layer processing and the MAC-hs sublayer processing are performed by a single digital signal processor.

22. A processing method as defined in claim 20, wherein the HSDPA physical layer processing and the MAC-hs sublayer processing are performed by two or more digital signal processors in a multiprocessor configuration.

23. A processing method as defined in claim 20, wherein the HSDPA physical layer processing and the MAC-hs sublayer processing are performed by two or more digital signal processors of the same type or family.

24. A processing method as defined in claim 20, wherein the HSDPA physical layer processing includes encoding of data units for transmission and storing retransmission data in a virtual buffer prior to the encoding of the data units.

25. A processing method for use in a base station of a wireless communication system, comprising:
maintaining one or more queues of data units to be transmitted from the base station to user equipment, wherein maintaining one or more queues is performed by one or more digital signal processors of a selected type;
scheduling transmission of the data units from the base station to the user equipment, wherein scheduling transmission is performed by the one or more digital signal processors; and
processing the scheduled data units for transmission from the base station to the user equipment, wherein processing is performed by the one or more digital signal processors.

26. A processing method as defined in claim 25, wherein processing the scheduled data units comprises at least part of symbol rate processing of the scheduled data units.

27. A processing method as defined in claim 25, wherein processing the scheduled data units comprises spreading and modulation of the scheduled data units.

28. A processing method as defined in claim 26, wherein processing the scheduled data units further comprises at least part of chip rate processing of the scheduled data units.

29. A processing method as defined in claim 25, further comprising processing transmissions from the user equipment to the base station, wherein the step of processing transmissions from the user equipment to the base station is performed by the one or more digital signal processors.

30. A processing method as defined in claim 29, wherein processing transmissions from the user equipment to the base station comprises scheduling retransmission of data units that are not acknowledged by the user equipment.

31. A processing method as defined in claim 29, wherein processing transmissions from the user equipment to the base station comprises processing acknowledge/not acknowledge signals corresponding to data units transmitted from the base station to the user equipment.

32. A processing method as defined in claim 27, wherein processing transmissions from the user equipment to the base station comprises adjusting transmission parameters in response to channel quality information received from the user equipment.

33. A processing method as defined in claim 25, wherein maintaining one or more queues comprises maintaining queues according to priority for two or more users.

34. A processing method as defined in claim 25, wherein maintaining one or more queues of data units, scheduling transmission of the data units and processing the scheduled data units for transmission are performed by a single digital signal processor.

35. A processing method as defined in claim 25, wherein maintaining one or more queues of data units, scheduling transmission of the data units and processing the scheduled data units for transmission are performed by two or more digital signal processors in a multiprocessor configuration.

36. A processing method as defined in claim 25, wherein maintaining one or more queues of data units, scheduling transmission of the data units and processing the scheduled data units for transmission are performed by two or more digital signal processors of the same type or family.

37. A processing method as defined in claim 25, wherein processing the scheduled data units for transmission includes encoding the data units for transmission and storing retransmission data in a virtual buffer prior to the encoding of data units.

38. A processing method for use in a wireless communication system, comprising:
performing at least part of physical layer processing in one or more digital signal processors, wherein the physical layer processing includes encoding of data units for transmission and storing retransmission data in a virtual buffer prior to the encoding of the data units.
